(19) United States
(12) Patent Application Publication
(10) Pub. No.: US 2005/0071988 A1
(43) Pub. Date: Apr. 7, 2005

(54) Apparatus for fastening weld fasteners to a structure

(76) Inventor: Jeff Owel, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 10/679,636

(22) Filed: Oct. 6, 2003

(51) Int. Cl. B23Q 15/00; B23P 21/00

(52) U.S. Cl. 29/711; 29/709; 29/720

(57) ABSTRACT

An apparatus for presenting components stored in stackable trays, and removing empty trays comprising a base member having an input and an output portion; a discharge area; a shuttle member which removes empty storage trays and places them in the discharge area; and a shuttle supporting member.

### BACKGROUND AND SUMMARY OF THE INVENTION

The present invention relates to devices for controlling delivery of work pieces to welding stations in manufacturing or assembly operations and, more particularly, to an improved system for delivering and positioning on work pieces at production line workstations having stud welding operations.

### FIELD OF THE INVENTION

As is well known, assembly or production line facilities require the delivery and temporary storage of large volumes of production parts at or near assembly or production line workstations to support worker line operations on a continuous mass production basis. Automotive production line or assembly line operations in particular require the delivery of large and varying numbers of parts of varying sizes for assembly to automotive or truck vehicles or subsystems thereof, on a continuous basis.

Due to the fact that mass production operations require the continuous delivery of a large number of such parts during any particular work shift, typical assembly line operations require movement, positioning and temporary storage of large numbers of stackable pallets filled with various components at the production facility. In this regard, various components often require varying automated processing. These process often include spot welding, painting or the welding of weld studs. Often, however similar but not identical processing, requiring a single type of machine, can be conducted on varying types of work pieces. Dedicated machinery however increase the cost and floor space requirements of a production system. Furthermore, a single work piece can require varying processing at various workstations depending on the post processing use of the work piece.

It is, therefore, desirable to provide a production parts delivery system which facilitates the delivery of fresh pallets or containers of parts to a set of production line work stations as needed. It is also desirable to provide such a system which reads information from the container to trigger a predetermined robotic sequence. It is further desirable to provide such a system which positions full production part containers as desired adjacent a plurality of work stations which have associated robots and fastener welders.

The present invention is intended to satisfy the above desirable features through the provision of a new and improved stud welding system which is designed in structural modules operative to define a base portion having an input and output portion and an optical scanning system, a shuttle or conveyor for conveying the components in trays to work stations.

In one embodiment of the invention, a system is provided to regulate the flow of components a direct them to specific processing. The system utilizes a robotic system to move components from a movable tray to a work position configured to weld a fastener onto the component. The robotic system utilizes tracking systems to initiate which work station or work stations the robots will transport the work piece to.

In another embodiment of the invention, the system utilizes an optical system to trigger a specific robotic sequence. The sequence can incorporate movement of the component either using a robotic arm or by movement of the pallet. The component is moved to one or more work stations which fastens at least one weld fastener to the component using a welding machine. The robot is then configured to move the component to another location for further fastener welding or into a transportable tray.

The above and other features of the invention will become apparent in the reading of the detailed description of the preferred embodiments, which makes reference to the following sets of drawings.

### BRIEF DESCRIPTION OF THE DRAWINGS

FIG. 1 is a top view of a delivery system in accordance with one embodiment of the present invention; and

FIG. 2 is flow chart describing the control of the system in FIG. 1.

### DETAILED DESCRIPTION OF THE PREFERRED EMBODIMENTS

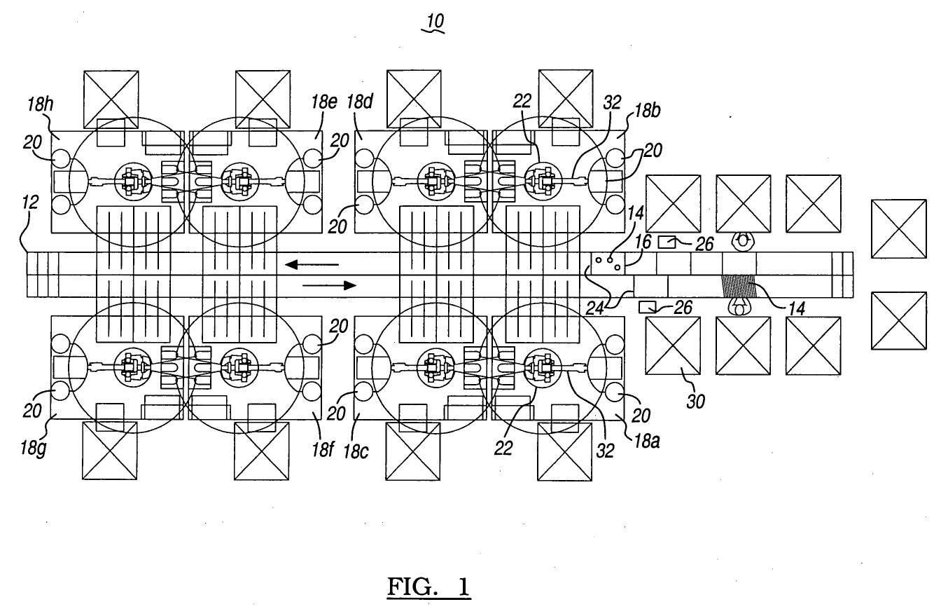

Referring now specifically to the drawings, a container storage and delivery structure and system in accordance with one embodiment of the present invention is indicated generally in FIG. 1. The system 10 is centered around a conveyor system 12, which is configured to transport various work pieces 14 in stackable component trays 16. Disposed about the conveyor 12 is a plurality of work stations 18a-18d. Each work station 18 contains fastener welding equipment 20 configured to weld one or more types of weldable fasteners such as studs or weld nuts onto the various work pieces 14. Disposed between the work stations 18 are a plurality of robots 22a-22d which are programmed to transport the work pieces 14 from the stackable trays 16 to the welding equipment 20. Optionally, the conveyor 10 can be coupled to the work station using a pallet interchange conveyor 23.

The conveyor 12 is configured to transport numerous types trays 16. Each of the varying trays 16 can contain differing types of components or work pieces 14. Optionally, the varying trays 16 can contain one or more types of components. Each of the trays 16 has a tag 24 which is used by the system 10 to determine which components 14 are within the tray 16. In this regard, the system 10 has a reader 26 disposed adjacent to the conveyor 12 which reads the tag 24. The reader 26 can read optical or electromagnetic signatures indicative of the identification tag 24. The system 10 uses information from the tag 24 to determine which software loop 28 to initiate within a system controller 30.

The system controller 30 as a plurality of control program loops 28 which function to control the movement of work pieces 14 through the system 10. Coordinated together are the conveyor 12, the robots 22a-22d and the weld equipment 20. Depending on the work pieces 14 found in the tray 16, the conveyor 12 will transport the tray 16 to a given position. A robotic arm 32 of the robot 22 will then grasp one of the work pieces 14 within the tray 16 and move it to a first work station 18. At the work station 18, a first weld machine 20 will couple a first weld stud to the work piece 14. The robotic arm 32 then either indexes the location of the work piece 14 with respect to the stud welder 20 for the fastening of a second stud to the work piece 14, or returns it to the stackable tray 16.

At this point, the instruction set for the indexes the robot arm 32 to recursively perform its operation of the set of work pieces 14 within the stackable trays 16. As each stackable tray 16 may have different types of work pieces 14 stored within, the robotic sequence of the robotic arm 32 may be different for each work piece 14 within the tray 16. In this situation, the robot 22 is instructed to retrieve the work piece 14 and position it properly within the welding equipment 20. The welding equipment 20 is then instructed by the system controller 30 to fasten a weld stud onto the work piece 14.

After the processes have been completed on the identified work piece 14 within the stackable trays 16, the tray 16 is then forwarded to a second station 18b. At this point, a second robot functions 20b to remove work pieces 14 within the stackable tray 16 and proceeds to position them with respect to a second weld stud machine 20b. As with the processes associated with the first location, the system recursively processes the required components within the tray 16.

Optionally, the movement of the first tray 16 to the second position 18b, allows the system to move a second stackable tray 16 into the first location 18a. At this point, the optical reader 26 reads a second set of information from the second tray 16. This allows the system to index and determine what the appropriate control loop is required for processing the components in the second stackable tray. In this way, the system 10 can simultaneously have a plurality of instruction sets and, therefore, welding processes running for various trays 16.

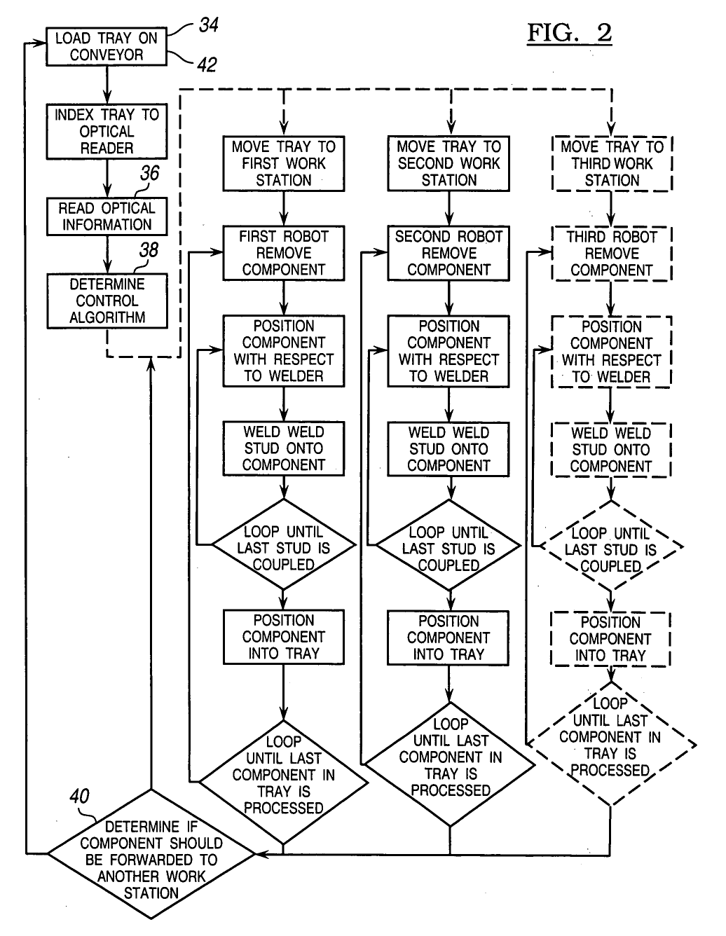

Reference is now made to FIG. 2 which represents a flow chart describing the functioning of the present invention. The system 10 begins at process block 34 where a first stackable tray 16 containing at least one work piece 14 is loaded onto the conveyor 12. At this point, the conveyor 12 is indexed, bringing the stackable tray 16 into position where the optical reader 26 can read the optical information off of the optical tag 24. In process block 36, the system 10 uses the optical reader 26 to read the optical information off of the tray. In process block 38, the system now determines which control loop or loops are appropriate for the processing of the components 14 within the tray 16. These control loops are a set of instructions for controlling the flow of the stackable containers within the system 10, and more particularly the flow of components through system 10. Additionally found within the control loop as are sets of instructions for the one or more robotic arms 32 as well as for one or more stud welders 20 within the system 10. Upon initiation of the control loop, the tray 16 is indexed to the required work station 18.

At the first work station 18, the robot 22 of the work station 18 begins to remove individual components 14 from the stackable tray 16 and bring the components to the first weld stud machine 20. A first sized weld stud is coupled to an exterior surface of the work piece 14. At this point, the work piece 14 is optionally shifted with respect to the weld stud machine 20 to fasten a second stud to an exterior surface of the work piece. This process is repeated until all of the weld studs for a particular work piece 14 which are to be fastened by the first weld stud machine 20 have been coupled. The robot 22 then returns the work piece 14 to the stackable tray in an orientation which may be different that the original orientation of the component. The system 10 will recursively repeat the above steps for the number of components which must be processed in the first work station.

In process block 40 the system 10 actuates the conveyor 12 so as to position the stackable tray 16 at the second work station 18b. At the second work station 18b, the robot 22b of the work station 18b begins to again remove individual components 14 from the stackable tray 16 and bring the components 14 to a second weld stud machine 20. A second sized weld stud is coupled to an exterior surface of the work piece 14. At this point, the work piece 14 is optionally shifted with respect to the weld stud machine 20 to fasten a second stud to an exterior surface of the work piece 14. This process is repeated until all of the weld studs for a particular work piece 14 which are to be fastened by the second weld stud machine 20b have been coupled.

The robotic arm 32 then returns the work piece 14 to the stackable tray 16 in an orientation which may be different that the original orientation of the component within the tray 16. The system 10 will recursively repeat the above steps for the number of components which must be processed in the first work station.

In process block 42, a second stackable tray 16 containing at least one work piece 14 is loaded onto the conveyor 12. At this point, the conveyor 12 is indexed, bringing the second stackable tray 16 into position where the optical reader 26 can read the optical information off of the tray. In process block 44, the system 10 uses an optical reader 26 to read the optical information off of the tray. In process block 46, the system 10 now determines which control loop or loops are appropriate for the processing of the components within the tray. Upon initiation of the control loop, the tray is indexed to the required first work station.

At the first work station 18a, the robot 22 of the work station begins to remove individual components 14 from the second stackable tray 16 and bring the components 14 to the first weld stud machine 20 for the second tray 16. A first sized weld stud is coupled to an exterior surface of the work piece 14. At this point, the work piece 14 is optionally shifted with respect to the weld stud machine 20 to fasten a second stud to an exterior surface of the work piece 16. As previously described, the process is repeated until all of the weld studs for a particular work piece which are to be fastened by the first weld stud machine for the second tray 16 have been coupled. The robotic arm 32 then returns the work piece 14 to the stackable tray 16 in an orientation which may be different that the original orientation of the component. The system 10 will recursively repeat the above steps for the number of components which must be processed in the first work station 18a.

1. An apparatus for presenting and processing components stored in stackable trays, comprising:
a conveyor system having an input and an output portion;
a plurality of work stations, each workstation having an associated robot and weld fastener welder;
a reader positioned adjacent the input portion; and
a controller operatively connected to the reader, conveyor, the robots, and the fastener welder, said controller being operable to activate one of a plurality of software loops upon based on a first signal received from the optical reader.

2. The apparatus of claim 1 wherein the each stackable tray comprises an indicia indicative of what components are found within the stackable tray and wherein the controller functions to initiate a first control pattern based upon the type and number of components within the stackable tray.

3. The apparatus of claim 1 further comprising a first stackable tray comprises a first indicia and a second stackable tray comprising a second indicia, said controller configured to take the first stackable tray into the input portion and read the indicia, said controller further configured to move the first stackable tray to a first tray first location.

4. The apparatus of claim 3 wherein the controller further configured to move the first stackable tray to a second tray location.

5. The apparatus of claim 3 wherein the first tray location is a first work station.

6. The apparatus of claim 4 wherein the second tray location is a second work station.

7. The apparatus of claim 5 wherein the first work station comprises a first robot and a first weld fastener welder.

8. The apparatus of claim 7 wherein the first robot is configured to remove components and position them in an orientation so as to allow the welding of a weld fastener.

9. The apparatus of claim 8 wherein the first fastener welder fastens a weld fastener to an exterior surface of the component.

10. The apparatus of claim 6 wherein the second work station comprises a second robot and a second weld fastener welder.

11. The apparatus of claim 10 wherein the second robot is configured to position the component in a position so as to allow the fastening of a second weld fastener welder.

12. The apparatus of claim 11 wherein the second weld fastener welder is configured to weld a second weld fastener to a second location on the component.

13. The apparatus of claim 12 wherein the second fastener welder is configured to weld a third fastener to a third location on the component.

14. The apparatus of claim 7 wherein the first weld fastener welder is configured to weld a fourth weld fastener onto a second location on the component.

15. An apparatus for presenting and processing components stored in stackable trays, comprising:
a conveyor system having an input and an output portion;
a plurality of work stations, each workstation having an associated robot and weld fastener welder;
an optical reader positioned adjacent the input portion; and
a controller operatively connected to the optical reader, conveyor, the robots, and the fastener welder, said controller being operable to activate one of a plurality of control loops upon based on a first signal received from the optical reader.

16. The apparatus of claim 15 wherein the control loop functions to control the movement of a least one robot and at least one weld fastener welder.

17. The apparatus of claim 15 comprising a first stackable tray having a first indicia and a second stackable tray having a second indicia.

18. The apparatus of claim 17 wherein the conveyor is configured to move the first and second stackable trays to one of the work stations in response to instructions from the controller.

19. The apparatus of claim 16 comprising a first work station having a first robot and a first weld fastener welder.

20. The apparatus of claim 19 comprising a second work station having a second robot and a second weld fastener welder configured to weld studs to an outer surface of the component.
